(19) United States
(12) Patent Application Publication
(10) Pub. No.: US 2015/0186878 A1
(43) Pub. Date: Jul. 2, 2015

(54) Computer-Implemented System for Providing Payment Information for a Transaction Subject in a Location

(71) Applicants: James LeBoeuf, Oklahoma City, OK (US); Sandra LeBoeuf, Oklahoma City, OK (US)

(72) Inventors: James LeBoeuf, Oklahoma City, OK (US); Sandra LeBoeuf, Oklahoma City, OK (US)

(21) Appl. No.: 14/143,581

(22) Filed: Dec. 30, 2013

(51) Int. Cl. G06Q 20/38; G06Q 20/32; G06Q 20/22

(52) U.S. Cl. CPC G06Q 20/387; G06Q 20/22; G06Q 20/3224

(57) ABSTRACT

A computer-implemented system for providing payment information for a transaction subject in a location, the system comprising a database, user interface, a user device communicating with the user interface, a transaction subject input engine interactively facilitating each user input of data related to payment for a transaction subject and generating a database record related to the transaction subject, a transaction subject output engine having a query generator interactively facilitating each request and generating a query closely related to the transaction subject and location in view of applicable adjustment factors, and a response generator receiving the query and applying adjustment factors to relevant transaction subject payment data to generate a response including expected price information for the transaction subject in the location, whereby an expected price for a particular transaction subject at a specific location is determined as a function of a user request and application of applicable adjustment factors.

### CROSS-REFERENCE TO RELATED APPLICATIONS

None.

### FIELD OF THE INVENTION

The present invention generally relates to interactive computer systems, such as interactive websites. In particular, the invention relates to a system and method for sharing payment information about an actual payment transaction for a specific good or service (what will be called a “transaction subject”) in a specific location and using that information to identify what a user in similar situation and location would expect to pay, i.e. “share what's fair,” thereby providing a baseline for the negotiating process for the price of goods or services predominantly in non-fixed-price environments.

### BACKGROUND

Many world travelers are from western countries were the price of a product or service is typically fixed with little or no negotiability. Many countries lack fixed-price environments: bargaining and negotiating is part of the culture, and the price to be paid for a product or service is typically negotiable. In those areas of the world where the prices are fixed, it is relative easy to search and find those prices on the Internet. However, in areas of the world where the prices are fully negotiable, and in secondary markets such as garage sales and flea markets there is currently no system to provide price information to the consumer on what a fair market price may be for a product or service.

As mentioned above, the most common method of determining prices at a location or at a merchant before actually visiting is searching the Internet because it is widely used by merchants to advertise their product or service. Many merchants use websites or other online tools to advertise their product or service such as Craigslist or Ebay. When there are multiple merchants selling the same or similar product or service, comparing prices is relative easy, but when the product or service is sold through a negotiable or secondary market, estimating the price is much more difficult and as a consumer you want to pay a fair price, and not be taken advantage of by paying an overinflated price.

To address this information deficit, the current invention allows users to populate a database through a website based on purchases made throughout world at different merchants or by knowledgeable users having interaction with various merchants and markets. This database then provides a user the ability to request an expected price for a specific product or service based on multiple factors such as location, season, currency exchange rate, and the level of negotiations. Two examples illustrate the way in which the invention may be used.

The first example is a traveler in Bangkok, Thailand who plans to go to the Chatuchak Weekend Market and buy a piece of “Dragon Fruit.” Before traveling to the market, the user enters the product or service query information about the desired good, a “Dragon Fruit,” and the desired location, Bangkok, Thailand. Then user's query would be used to search the database and return an expected price based on the data and analysis factors that most closely matches the criteria. In this specific case, a user currently in Bangkok may have purchased a “Dragon Fruit” yesterday in the market for a specific price and another user may have bought the fruit two weeks ago in the same market and some other user may have bought the fruit in another market some miles away a year ago. The invention would use an algorithm applying various adjustment factors to determine an expected price for a “Dragon Fruit” in Bangkok, Thailand at that market based on these purchases of other users in similar locales. This allows users to share their product or service pricing with other users who want to purchase the same or similar product or service under similar conditions. This is an example of how a traveler could use the invention.

Another example of how the invention could be used locally is when a user at a local farmer's market needs the current price of tomatoes to determine if the price the farmer is asking for the tomatoes is fair. For this determination, the user logs onto the website operated in the present system using a mobile device and enters the information as described previously. The invention returns to the user the expected price that was paid by other users that had visited that market and/or other surrounding markets. The user can then compare the expected price to asking price and determine if the price the seller is asking is fair. These are two examples of how the invention may be employed but these examples in no way describe the limits of its use.

### SUMMARY OF THE INVENTION

The invention relates to a system and method for providing one or more expected prices of a product including, but not limited to, such items as clothing, food, sundries, anything tangible, or a service including, but not limited to such services as an oil change, a moped rental, a vacation excursion, to a user requesting the information based on previously obtained price information submitted by other system users. A user requests the expected price of a product or service in order to determine if the price they are going to pay for the product or service is considered fair or if they should continue to negotiate the price lower approaching the expected price. More particularly, the invention relates to a user interacting with the system wherein a user has at least four common choices for interacting with the system: creating an account and maintaining it; adding a transaction subject to the database; requesting a transaction subject expected price; and entering data rating the various aspects of the transaction or the vendor. After the account is created, the user may maintain the account by updating their user profile information and password. A user may add a transaction subject to the database by, for example, selecting a category appropriate to the transaction subject type, provide a description of the transaction subject, the location where the transaction subject was purchased, the size and quantity as appropriate, the currency used to purchase the transaction subject, the date of purchase, and a transaction review. The review can be about the transaction subject or the transaction experience. A user may request an expected price on a transaction subject based on the user-defined search criteria entered into the database query via the website. The query may include but is not limited to such items as category, common name or description, location or time frame. Once this information is entered, the system calculates an expected price. The expected price is determined by identifying the transaction subjects in the database that most closely match the requested search parameters and applying an algorithm to this set of transaction subjects entered by other users. After the application of the algorithm, the user will receive an expected price that has been adjusted appropriately and takes into account factors including, but not limited to recency of a purchase, distance between desired purchase location and actual purchase locations, and currency exchange rates. The system will display the expected price and may also display the associated transaction subject's information located in the database, their reviews, and the level of recognition they have received through their use.

U.S. Pat. Pub. No. 2013/0035993 to Hungate, teaches methods and systems for online quoting and facilitating buyer and seller interactions and instant price quoting for online products or services based on user input. This invention is targeted at the online retail market and the actual purchase of goods and services online. U.S. Pat. Pub. No. 2009/0281875 to Tarka, teaches a system for recommending for collecting information from travelers regarding their trip and then, based on the collected data, providing recommendations to a traveler. Tarka provides recommendations associated with the primary retail travel market including such goods and services such as airlines, hotels, and other travel service providers. U.S. Pat. Pub. No. 2013/0024391 to Vakil, teaches a system for identifying users of a traveler's social network who may possess travel information of interest to the user where the system seeks out members of the traveler's social network that have experiences in the same area where a traveler is requesting information. This invention has a significant limitation in that a user's ability to receive recommendations is based on the size of their social network. Additionally, the information received will be targeted to the retail travel market and the decision whether or not to select a particular destination, place of lodging or tour. None of the foregoing teach a system for user-provided pricing data that can be summoned to estimate the price for a good or service in a variable-price market.

The present invention overcomes these shortcomings in the prior art by providing a system and method for providing payment information for a good or service in a primary retail market and secondary markets such as bazaars, garage sales, flea markets based on what others have paid for the same or similar goods and services and not what retailers suggest. These payments are not limited to a specific industry as noted in the prior art above. Additionally, the present invention takes into account geography, season, currency exchange rate, inflation rate, availability, size, recency, distance, market variables, political boundaries, user credibility, level of negotiation, and statistical analysis to develop an expected price without undue influence of retailers.

The present invention fulfills the need for providing expected prices in an established economy with little negotiating to an economy where the art of negotiating is part of the culture. It brings the experiences of multiple users together in one location and allows them to “share what's fair” with other users that plan to visit the same area.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a diagrammatic representation of one embodiment of the payment system in the form of networked computer system.

FIG. 2 is a diagram illustrating the contents of a version of a database

FIG. 3 is a process flow diagram illustrating one method for creating an account.

FIG. 4 is a process flow diagram illustrating one method for selecting a user action.

FIG. 5 is a process flow diagram illustrating one method for adding a transaction subject and payment information.

FIG. 6 is a process flow diagram illustrating one method for requesting a transaction subject payment information.

### DETAILED DESCRIPTION OF THE INVENTION

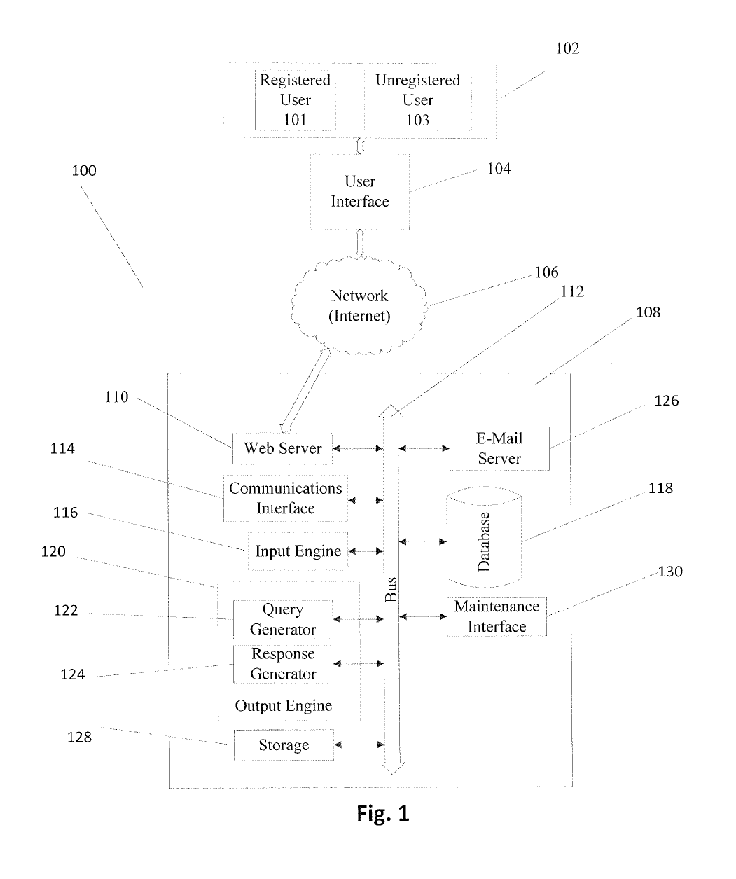

FIG. 1 is a diagrammatic representation of one embodiment of a system 100 according to the present invention. This preferred embodiment includes a user 102, a user interface 104, a network system 106 and finally, a computer system 108 and its components. The user 102 is a person who interacts with the system 100 via the user interface 104 where that person can be anyone from a world traveler to someone locally attending garage sales or flea markets.

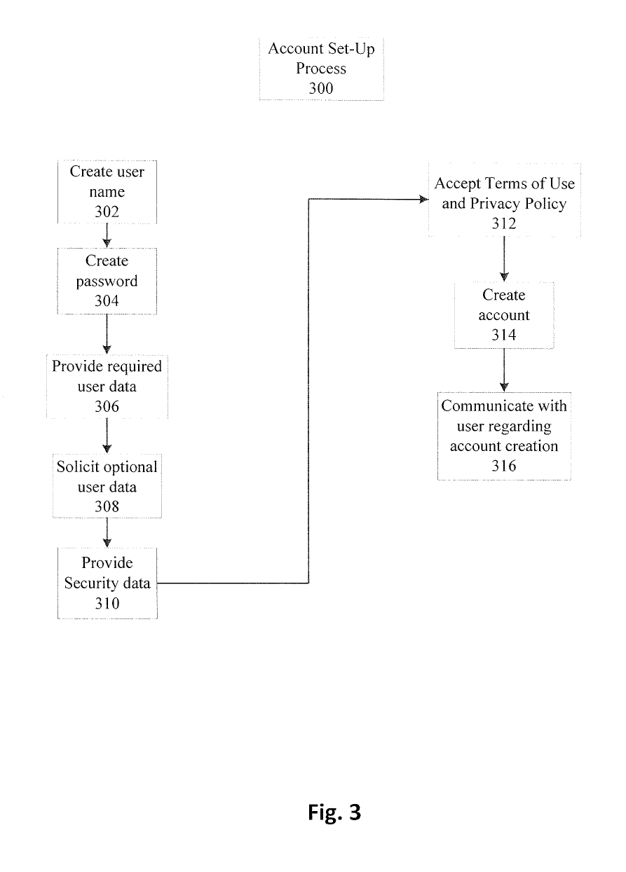

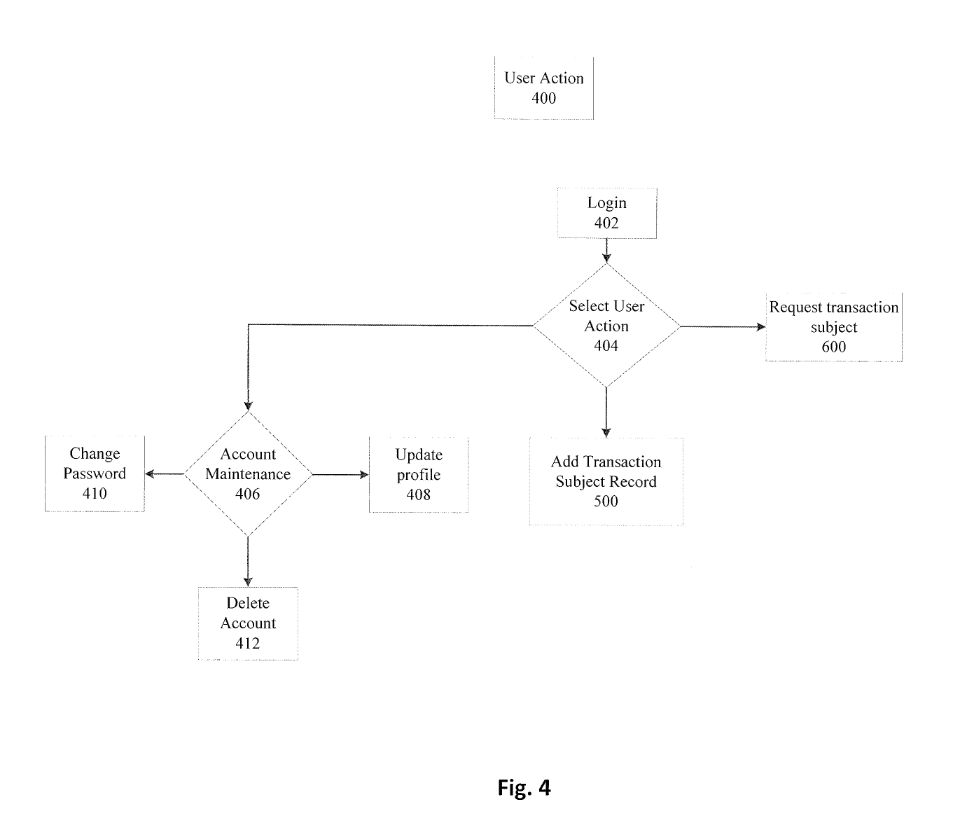

User 102 can include persons separated into two categories: first the registered user 101 and second, the unregistered user 103. A registered user 101 is one who creates an account and a user profile 200 with preferences within the system. Once a user's 102 account is created, the now-registered user 101 may employ all the registered user 101 functions of the system 100 through the user interface 104. This account setup process 300 and available user actions 400 will be further discussed in FIG. 3 and FIG. 4, respectively. The unregistered user 103 may be allowed to submit a transaction subject data 202 to the system 100. The unregistered user 103 may also retrieve information about selected transaction subject data 202 from the system 100. However, the unregistered user 103 preferably has more limited capabilities with respect to the system 100 than a registered user 101.

The user interface 104 enables a user 102 to communicate with the system 100. The user interface 104 has a hardware component and a software component, though the software component may not be permanently installed on a user device. The hardware component is a user device which may be a desktop, a laptop, or a mobile device such as an iPhone®, Blackberry®, a tablet, or similar devices. The user device communicates with the network 106 and the software component of the user interface 104. The software component of the user interface 104 preferably consists of a graphical user interface (GUI) or a mobile application that allows a device to connect to through the network 106 to a website hosted on the system hardware 108. The user GUI may consist of a standard Internet web browser such as Internet Explorer®, Firefox Mozilla®, etc., in communication with the system website GUI. The mobile application may be a software program tailored to its specific mobile device platform and, if installed on the user device, is preferably downloadable from the web site by the user. This combination of hardware and software enables a user 102 to interface with the system hardware 108.

Once a user 102 has connected to the system hardware 108, the user 102 through the user interface 104 can now access multiple functions of the system. The user 102 may register for an account, enter data relating to a transaction subject 204, or request transaction subject data 202 relating to expected price 616 of a transaction subject 204. Additionally, the user 102 can select the query adjustment factors 228 to apply to the request where the user 102 will receive an expected price 616 based on the adjustment factors 228 selected. Also, the user interface 104 allows for periodic system maintenance and system administration.

A user 102 may register for an account using the user interface 104 and become a registered user 101 or choose to stay an unregistered user 103, which allows access with certain limitations. The details of registering for an account and subsequent profile creation are described below. Both registered and unregistered users 102 preferably have the ability to add a transaction subject 204, upload photographs, and otherwise contribute information to the website. A registered user 101 will have full access to the system 100 user functions. However, an unregistered user 103 will have limited use of the system 100 functions and may be unable to flag transaction subjects, share stories and experiences, and become a “trusted user.”

A user 102 may enter transaction subject data 202 into the system database 118. The transaction subject 204 is categorized and stored in the database 118, which is described in further detail below. Additionally, other data may also be entered such as transaction review data 220, adjustment factors 228 data, pictures, and shared stories by a registered user 101 about their experience and suggestions for other users 102. This data populates the database 118 enabling other users to capitalize on someone else's experiences by sharing what's fair. To capitalize on this information, a user may select one of several approaches to request an expected price 616.

One way of using the system is pre-planning a trip to see what the current prices are at a selected location where the user 102 may shop. This allows the user 102 to predict roughly, what the cost of a transaction subject 204 should be in that area, helping them more accurately budget for the needed transaction subjects 204.

Another method is the “on the go” expected price 616. This method is utilized by a user 102 when they are in a location and need an idea of what the expected price 616 may be for a specific transaction subject 204. Here, using a mobile device such as a smart phone, the user 102 using the mobile application described above would be able to connect with the system 100, enter the transaction subject data 202 and receive an expected price 616. This method allows a user 102 “on the go” to get expected price 616 information about a transaction subject 204 based on other user's 102 inputs having purchased or knowledge of the same or similar transaction subject 204 within that general location. Another useful on-the-go feature of the system is the ability to request a particular transaction subject and to allow the system to suggest nearby vendors 218 who are expected to offer the transaction subject 204.

The network 106 is preferably a standard world wide web network allowing a user 102 anywhere within the world with a network connection to connect to the system 100 through the user interface 104. This network 106 enables a user 102 to communicate with the system website to access the system functions. The network 106 is the link between the user interface 104 and the system hardware 108.

The system hardware 108 may consist of a web server 110, a databus 112, a communications interface 114, an input engine 116, a database 118, an output engine 120 which can be further delineated into a query generator 122 and a response generator 124, an email server 126 and a storage device 128 and finally, a maintenance interface 130. Each of these components will be described in further detail below. However, the delineation of these components does not indicate that the objectives of the system could not be accomplished in other ways. For example, a databus 112 is expected to be used, but it is not an element of the claims, and thus its function could be accomplished by another configuration of hardware or software components, as an example.

The web server 110 hosts the system website in order to deliver web content to the users 102 which can be accessed through the network 106. This web server 110 controls the user 102 access, the user's 102 input request and displays the results generated by the response generator 124. The web server 110 allows a user 102 to become registered user 101 through the account set-up process 300 described later in further detail. The web server 110 is the interface between the network 106 and the system hardware 108, which communicates with the rest of the components in the system hardware 108 via a databus 112.

The databus 112 provides the data highway between all the components within the system hardware 108. The communications interface 114 in conjunction with the databus 112 control the inward information flow coming from the web server 110 in the form of transaction subject 204 requests or transaction subject 204 inputs that need to be acted upon by the input engine 116 to the outward information flow as created by the output engine 120 and its associated components the query generator 122 and the response generator 124. Additionally, the communications interface 114 controls the information flow to and from a database 118, a storage 128 device, a maintenance interface 130 and an electronic mail (e-mail) server 126.

The input engine 116 interactively facilitates the user 102 inputs. The input engine 116 accepts the information entered by a user 102 via the website. The interactive process may prompt a user 102 to provide a description, to select a category, to describe the size/quantity in the transaction subject 204, and to provide additional clarifying information so that the data provided most accurately reflects both the transaction subject 204, its price, and the other relevant characteristics related to a transaction. The system then generates a database record based on the input of a transaction subject 204 with all its associated information such as the size and quantity 206, price and currency 208, the purchase location 210, the purchase date and time 212, the transaction subject quality 214, the category 216 of transaction subject 204, reviews 224, and the size and quantity 206 of the transaction subject 204. The user 102 may manually enter this information into the input engine 116 by the user interface 104.

Alternatively, all or some portion of the transaction subject data 202 may be entered into the system by scanning the universal product code (UPC) or barcode or the quick response code (QRC) for the transaction subject 204, if available. Scanning allows an electronic device to read the code and translate it into useable information entered into the database 118. A code such as a UPC, barcode or QRC or the like associated with the good or service may be referred to as a “transaction subject code”.

The UPC is a one dimensional type of barcode that is widely used throughout the world especially in western countries for tracking transaction subjects 204 in stores. A UPC barcode in its most common form consists of unique 12 digit number assigned to a single transaction subject 204 and encoded into the barcode. Thus when a barcode is scanned, information about a specific transaction subject 204 is retrieved and displayed. This is one method for automatically entering transaction subject data 202 into the input engine 116. Another way to enter information automatically is through the QRC. The QRC is a type of matrix barcode or two-dimensional barcode and similar to the UPC in that it is scannable and contains transaction subject data 202 but the QRC has a greater storage capacity compared to standard UPC barcodes and has increased readability speed. Because of this increased storage capacity and speed more information may be included about a transaction subject 204 within the code without detrimentally affecting the system speed.

As indicated earlier, the purchase location 210 may be entered into the input engine manually through the user interface 104 and website as described above. However, if the user's 102 mobile device has an automatic positioning capability and it is active, the user 102 may submit the purchase location 210 and the purchase date and time 212 information using the automated positioning capability. The application may ask the user 102 if it is acceptable to allow the use of the user's 102 current location thereby making the current location and the purchase location 210 synonymous. The automatic positioning capability can come in one of many forms; multilateration, triangulation, global positioning, WI-FI, or a hybrid system incorporating two or more of the foregoing technologies.

Multilateration and triangulation are ground-based methods by which a user's 102 location is determined by series of radio towers communicating with the mobile device, using the time difference of arrival (TDOA) or angle of arrival (AoA measurements respectively, to determine a user's 102 location.

Global positioning uses a satellite navigation system known as Globalnaya navigatsionnaya sputnikovaya sistema or GLObal NAvigation Satellite System (GLONASS) operated by the Russian Aerospace Defense Forces systems spaced-based or the Navigation Satellite Timing and Ranging System (NAVSTAR) Global Positioning System (GPS) operated by the United States. Both systems use satellites to provide location and time information in all weather conditions, anywhere on or near the Earth where there is an unobstructed line of sight to four or more satellites.

Wi-Fi-based positioning system uses a database of Wi-Fi access points where the location is determined by the signal strength between the mobile device and the known locations of these access points in the database. Based on this information, the location can be determined by combining this data and locating a common intersection point. The more access points the greater the accuracy of the location of the user 102. This system is particularly useful in urban areas with high-rise buildings preventing the line of sight needed for GPS and the user 102 being indoors.

The hybrid positioning system uses a combination of the above positioning systems described to supplement the other systems to create a location solution. For example, one hybrid mode may be the “Assisted GPS” mode where the device may only have access to three satellites and the other system provides the remaining piece of location information in order to determine the user's 102 current location. If the user 102 decides not to allow the automatic positioning system to be utilized, then the user 102 must enter the location manually.

The input engine may capture and store the Internet protocol (IP) address of the user 102 that adds a transaction subject 204 to the database 118. This IP address is associated with a geographic location and it may be compared with the location manually reported by the user 102. If these are different then the transaction subject 204 may be flagged for future follow up. If upon follow up it is determined that, this user 102 is abusing the system then the administrator may block the specific user 102 via their user name, an IP address, or a range of IP addresses.

The database 118 stores all transaction subject 204 records, adjustment factors 228 and user 102 data. The database is preferably comprised of a set of tables including a user profile data 200 table, a transaction subject data 202 table, a review data 220 table, and an adjustment factors 228 table. Each table is described in further detail below. Generally, once a user 102 enters data with respect to a transaction subject 204 and adds the transaction subject 204 to the database via a website or mobile device application, each table accepts its piece of data entered by the user 102 and is stored within each table and associated with a single record. This configuration allows all the associated data to be retrieved by a user 102 based on a query.

The output engine 120 generates an expected price based on the user 102 requests to the query generator 122 regarding a transaction subject 204 and applying the appropriate adjustment factors 228 to the transaction subject 204. Once the expected price is determined the response generator 124 displays the results to the user 102. The results include the expected price 616, the associated transaction subject data 202 records and review data 220 associated with each record if available. The output engine can further suggest locations nearby where the transaction subject 204 may be located and purchased. To accomplish this task, the output engine 120 uses a query generator 122 and response generator 124.

The query generator 122 interactively facilitates the user 102 requests and generates user 102 based queries. The query generator 122 accepts the user's 102 input via the GUI interface and processes the request using an algorithm to find records that most closely correspond to the user's 102 entered information within a specified confidence level. Query settings within the algorithm may be adjusted based on the user's 102 preferences. For example, a predetermined distance setting may be selectable during the query generation wherein the transaction subjects 204 will only appear if they are within this predetermined distance selected. Other parameters are selectable within the query such as the appropriate adjustment factors 228 that need to be applied. These adjustment factors 228 further refine the query enabling a more pointed search as desired by the user 102. Not selecting these adjustment factors enables a broader search. Additionally, the user 102 can create predetermined search queries by preselecting the desired criteria and saving the search criteria as a “saved search” wherein the user 102 can connect to the system 100 and execute a saved search based on one of the user's 102 saved searches thereby quickly providing the user 102 with the desired information. Additionally, the query generator result interpreting a request based on the predetermined settings may include the following: transaction subject category, proximity of vendor, a review of vendor, review of transaction subject, and price. After the query parameters are selected, the user 102 executes the query that provides the search results to the response generator 124.

The response generator 124 receives the records and the associated information and determines the expected price 610 information by applying an algorithm to the selected records to establish a base price for the selected query inputs. After establishing the base price, the adjustment factors 228 are applied to the base price to create the expected price 616 of the transaction subject 204. These adjustment factors 228 may be selected from location 230, season 232, currency exchange rate 238, authenticity 240, inflation rate 234, transaction subject availability 236, size and quantity 206, the recency of the record being chosen, the distance from the user's 102 location to the record's location, other market variables, political boundaries, the user's 102 credibility that submitted the transaction subject data 202, the level of negotiation required to obtain the price of the transaction subject 204 and statistical analysis to determine whether the transaction subject 204 is within what one would consider reasonable as compared to the other transaction subject 204 records to which it is being compared. A user 102 may be allowed to provide input based on the user's 102 assessment of whether a transaction subject (particularly a “good” as distinguished from a service) is authentic. That is, a user 102 may be able to indicate that they believe a transaction subject may be a “knockoff” or copy of a brand name item. Additionally, when a user 102 requests an expected price 616 for an authentic transaction subject, only those that have not been identified as possible copies either through the user's 102 input or significant price variations from a baseline will be used for the calculation. Once these factors have been applied, the response generator 124 displays the expected price 616 to be paid for the transaction subject 204, appropriate currency for the location, pictures of the transaction subject 204, suggested local vendors and locations, and transaction subject data 202 from the selected records which includes price paid, location of the purchase and reviews. The display will also include a vendor that is believed to be offering the transaction subjects 204 requested based on the selection criteria. Additionally, the currency adjustment factor 228 may be set so the system will assume and display the expected price 616 in the local currency based on the user's 102 current location.

Once a response is created, there are several options available to the user 102 such as print or e-mail the displayed information, conduct a new search, select a specific record for more detailed viewing, and add to the electronic cart. A user 102 may send the displayed information to a printer or an e-mail address identified during the user setup 300. Additionally, the user 102 may discard the current results and begin a new search. The user 102 may select a specific transaction subject 204 record to see more detailed information about the specific transaction. If the user 102 has questions concerning a posted transaction, they may contact the submitting user 102 via the email server 126. This allows the user 102 to find out more detailed information about that transaction subject 204, the transaction, and the location 210 where the contributing user 102 has visited and to provide additional details for the requesting user 102 to use.

The transaction subject 204 may be selected and put into an electronic cart. The cart as defined can hold all of the selected transaction subjects 204 that the user 102 has requested. The user 102 may add additional transaction subjects 204 to the cart through other queries, remove transaction subjects 204 currently in the cart, or clear the cart of all the transaction subjects 204. This electronic cart is similar to a cart that would be used in a retail outlet whereby transaction subjects 204 are placed in the cart until the user 102 checks out whereupon they obtain the final price of the combined set of transaction subjects 204. This cart works effectively the same way except in the virtual world where the transaction subjects 204 can stay in the cart until they are removed or until the user 102 checks out. As a user 102 places the transaction subjects 204 into the electronic cart, an aggregate price is incremented every time a new transaction subject 204 is added to the cart. At checkout, the user 102 may save the cart they just populated for later use in a saved search or they may proceed with checking out. At this time, the user 102 will receive a total cart price with all the appropriate adjustment factors 228 applied to the transaction subjects and to the cart as a whole as required. Additionally, the response generator 124 may suggest vendors based on the total price of the cart with these transaction subjects 204 or based on the vendor that has the greatest amount of transaction subjects 204 that were requested or a combination thereof between the total amount of transaction subjects 204 and expected total price.

The e-mail server 126 provides the communication link between the users 102 and the system administrator. The administrator can communicate bidirectionally with the user 102 about their account and any issues they may have with respect to the system 100. Additionally, the e-mail server 126 allows a user 102 to contact another user 102 with respect to their posting without allowing either user 102 having direct access to one another or to the user's 102 e-mail account stored in their user profile.

Storage 128 provides a location to store the system hardware 108 operating system, the web server 110 software, the database 118 information including the associated tables and queries for the database and information associated with the e-mail server 126. The physical configuration may be in the form of a digital or a spinning mass hard drive. Additionally, the cloud may be used as a storage medium for some of the system information. Though the storage 128 is shown separate from the database 118 on FIG. 1, it should be understood that the database 118 and other system data may be maintained within the storage 128. Further, different types of computer storage may be encompassed within the storage 128. The system may use a hard drive for some types of data storage and chip-based memory for other types of storage.

A user maintenance interface 130 enables system administrators to update, upgrade the system, provide normal system maintenance, and provide administrative functions for the web site and system. One of these features is the ability of the administrator to mediate approval of users 102, comments, transaction subject 204 records, or other database information that is flagged based on administrator determined criteria. Users 102 are allowed to identify an issue to the administrator by “flagging” it, wherein an administrator is able to review the issue for possible problems and implement a solution if needed. For example, a price that is significantly different from the average price based on the same or similar query may be flagged thus identifying the user 102 as possibly untrustworthy with respect to their additions. The administrator can prevent a user 102 entering future transaction subject data 202 into the system if that user 102 has been flagged or their inputs are consistently out of range as compared to other users. The maintenance interface 130 allows the modification of the adjustment factors 228 described above that cannot automatically be updated.

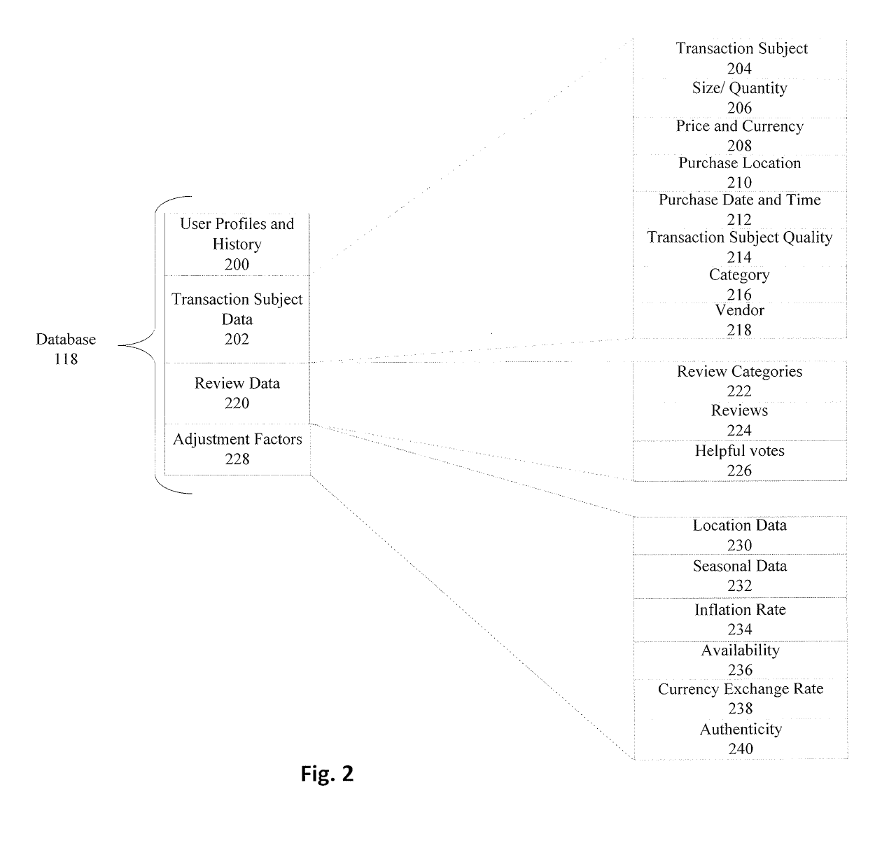

FIG. 2 illustrates the database 118 and its associated tables. Each time a user 102 submits transaction subject data, a unique record is created within the database. The database 118 may be divided into four tables: a user profile data table 200; a transaction subject data table 202, a review data table 220, and an adjustment factor data table 228. The user profile data table 200, the transaction subject data table 202, and the review data table 220 are populated by user-entered data, which is compiled to create each of these tables. Each time a user 102 adds transaction subject data 202 to the system it is parsed and placed in its element in the appropriate table. The output engine 120 retrieves elements of these tables and displays them per the user's 102 request.

The user profile data table 200 stores user 102 data pertinent data such as the user's 102 name, user's 102 password, required security data, other required user 102 data, and optional user 102 data. Other required user 102 data includes data such as their e-mail address, username, and location. The optional data can include a picture, a biography, and shared stories based on the user's experience. The method by which this data is obtained is further described in FIG. 3 in the account setup 300.

The transaction subject data 202 table may include the records of transaction subjects 204 entered by users 102 through the input engine 116. A Transaction subject 204 is any good or service that a user 102 may purchase. Initially, the database will be devoid of data until a significant number of users 102 begin to populate the database 118. However, the transaction subject data 202 table may be preloaded with a set of expected prices to overcome this initial startup limitation. This preloading may be accomplished using other data sources until the user 102 inputs achieve an acceptable level for normal operations. The transaction subject data table may comprise: a transaction subject 204 description; a size and quantity 206 description; the price and currency 208 used to purchase the transaction subject 204; the purchase location 210; the date and time 212 of purchase; the transaction subject quality 214; the transaction subject category 216; and a vendor 218 from whom the transaction subject 204 was purchased. The transaction subject 204 description allows a user 102 to describe the transaction subject 204 in varying amounts of detail as they desire. Each transaction subject 204 for which a database record is created, the user 102 will place the transaction subject 204 in a category 216 that is most appropriate. This categorization will contain multiple levels. To illustrate, the top level is populated with a series of general categories including, but not limited to food, services, beauty items, magazines, and books. Within these general categories, the transaction subjects 204 may be further subcategorized. For example, the general category for a transaction subject 204 may be a book that is then further delineated into a subcategory of books on history. Also, expected prices for a category 216 of transaction subjects 204 can be compared by location 230 and other adjustment factors 228. A specific set of transaction subjects 204 within the category 216 and common to the areas selected may be used for comparison. Once the selection occurs, the set is processed through the output engine 120 and the user 102 receives expected price 616 for both sets.

The review data table 220 consists of items such as review categories 222, reviews 224 and helpful votes 226. This data table stores information supplied by the user 102 where the user 102 rates the transaction subject 204 or the transaction with a vendor 218. The review with respect to a vendor may include the physical aspects of their establishment such as cleanliness and presentation to more nonphysical aspects of the transaction such communication and level of negotiation skills required. From these reviews, a vendor rating, a transaction subject rating, and a level of negotiation rating are created. Other user's may vote on how helpful the information was to them in their efforts and these votes are tallied and displayed when they receive their response.

Additionally, a user 102 may earn levels of certification and these levels may include “trusted user,” “world traveler,” “collector,” and “local” but are not limited to these levels. The “trusted user,” certification may be based on the reliability of their reviews, number of reviews, the location of their reviews and similar factors. The “world traveler” certification, for example, may require several reviews in a wide range of locations throughout a country or the world while a “local” may have a large number of reviews over time in a particular location. The collector may have superior knowledge in a specific area and provided reviews based on this knowledge. The certifications are displayed when the transaction subject 204 of a specific user is displayed. The system administrator will determine the specific requirements for a “trusted user,” “collector,” “world traveler,” and “local”. The foregoing labels are not intended to be definitive, but rather disclose the types of badges that a user 102 may earn indicating some degree of expected reliability associated with data they provide. This embodiment envisions a system where users 102 earn levels of certification based on factors including reliability of their reviews, number of reviews, location of reviews, details provided for the transaction subjects 204, and prior indicia of reliability. For example, if a particular user 102 provides reviews that are regularly rejected for inclusion in expected price calculations because that user's 102 submissions are statistically anomalous, this fact may prevent such a user 102 from becoming a “trusted user.”

The adjustment factor 228 data table stores the adjustment factors 228 that will be applied to the transactions subjects 204 to determine an expected price 616. The adjustment factors 228 can be manually or automatically updated. The adjustment factors 228 data table is preferably a combination of user 102 inputs, manual inputs, and third-party data used to create the table. The third party data may be updated automatically and may include data such as the current currency exchange rate and inflation rate for an area. These adjustment factors 228 include location 230, season 232, the currency exchange rate 238, the inflation rate 234, the availability 236 of the transaction subject 204 at the time of anticipated purchase, the size and quantity 206 of the transaction subject 204, the recency in which a like transaction subject 204 has been purchased in the same or similar area, the distance from where the user 102 would like to purchase the transaction subject 204, other market variables, political boundaries, the user 102 credibility as seen through the reviews and the ratings, the level of negotiation required and a statistical analysis whereby outliers not within what is considered normal are excluded.

FIG. 3 illustrates a method by which a user 102 may create an account on the system and gain access to the functions of the system 100 available to a registered user 101. A user 102 may select the account setup process 300 to initiate the account creation upon entering the website if they choose to become a registered user 101. The user 102 will create a username 302 and create its associated password 304. Additionally, the user 102 preferably provides the required user data 306 which preferably includes at least the first name, the last name and an email address in order to set up the account. The user 102 may add other optional data 308 to their account, such as a personal biography, a profile image, and experiences. The user 102 may provide security data 310 in order to protect the user's 102 account and to verify that the user 102 is who they claim to be when they log on to the system. Finally the user 102 must accept the terms of use and the privacy policy 312 before the creation of the account 314. After account creation, the system communication 316 will generate an email to the user 102 notifying the user 102 of the creation of their account.

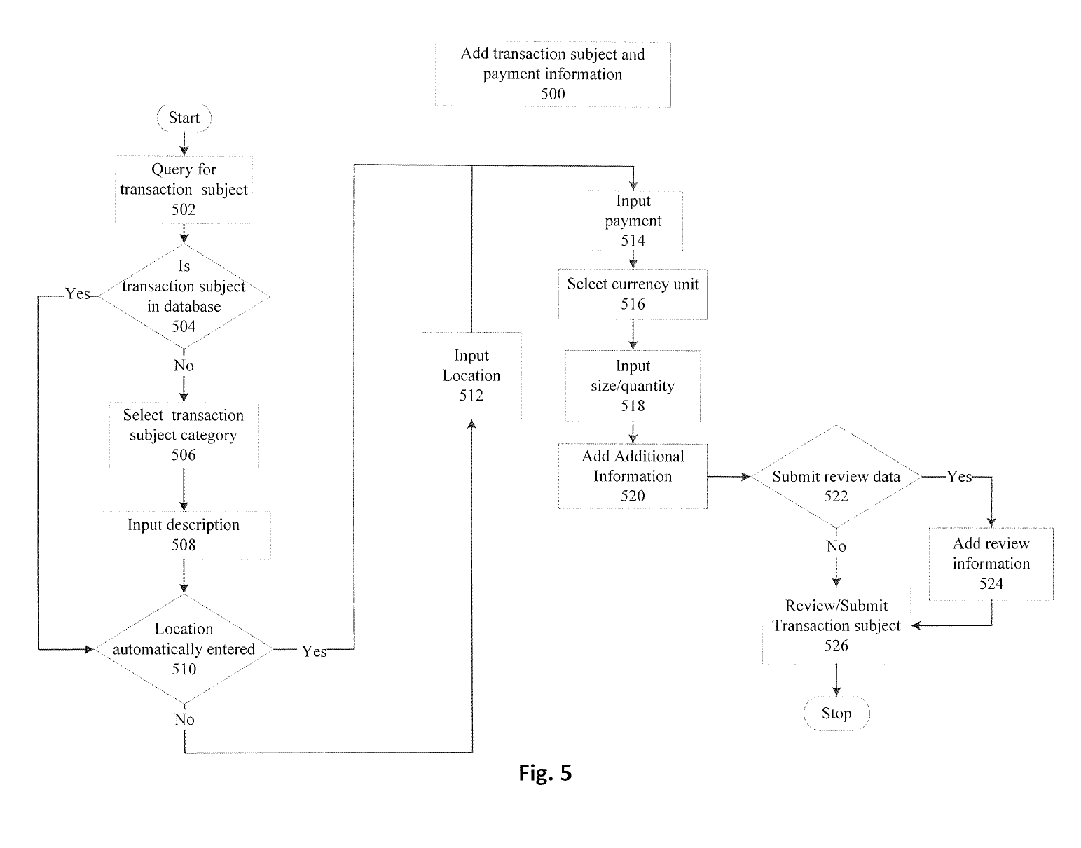

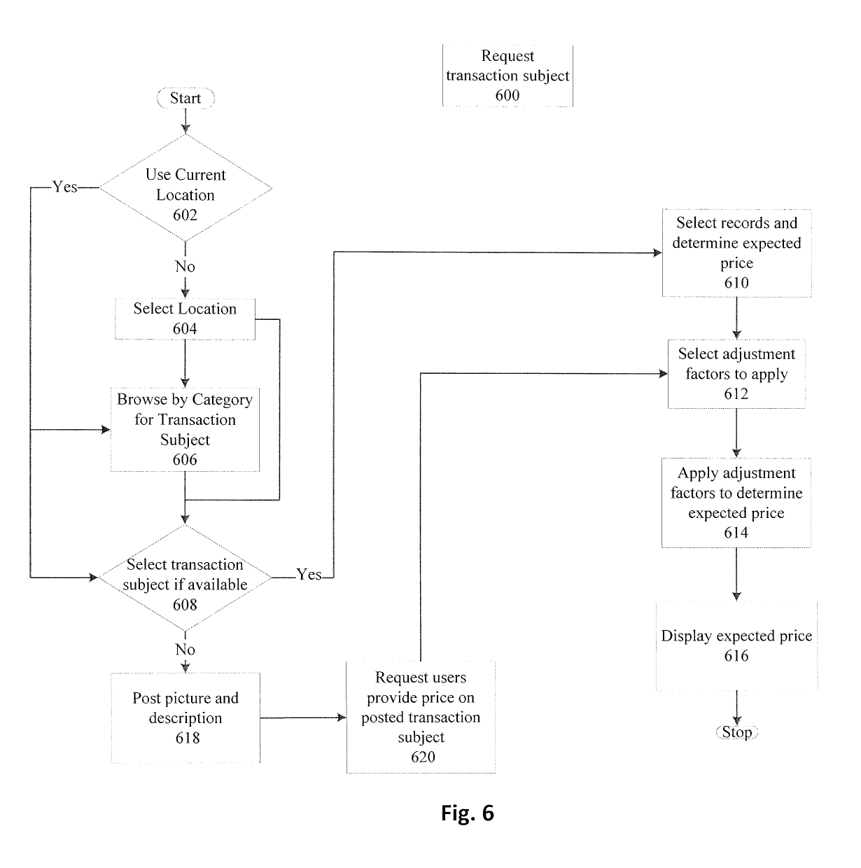

FIG. 4 illustrates the functions that are preferably available to a registered user 101. The user 102 logs into a login portal 402, which verifies their credentials, and then the registered user 101 selects the desired user function 404 from one of the following typical actions: account maintenance 406; add a transaction subject record 500 or request a transaction subject 600. Add a transaction subject record 500 or request a transaction subject 600 is described below in FIG. 5 and FIG. 6, respectively. Under account maintenance 406, the user 102 may choose to undertake a range of functions including changing their password 410, updating their profile 408 and deleting their account 412.

FIG. 5 illustrates one method of adding a transaction subject and payment information process 500 whereby a transaction subject 204 may be entered into the database 118 by a registered user 101 or, potentially, by an unregistered user 103. This process is initiated by a user 102 searching for a transaction subject 502. The next step in the process is to determine whether the transaction subject 204 is already in the database 504. Once this determination is made two options arise. The first option is if the transaction subject 204 is in the database 118 then the process skips to enter the location 510. If the transaction subject 204 is not in the database 118 then the process proceeds to the next step where the user 102 can select the transaction subject category for the transaction subject 506. Next, the input description 508 is entered by the user 102 to give a detailed description of the transaction subject 204. Once this step has been completed, the user 102 is at the same point in the process had the transaction subject 204 already been in the database 118. The next step addresses the location, where the location is automatically entered 510, if the user 102 desires this option and they are using a mobile device. If the mobile device has a positioning capability to provide the location automatically and the service is activated then that option is available to the user 102 to input their current location as the place that the transaction subject 204 was purchased. If the location is automatically entered 510 is not desired, then the process directs the user 102 to the next step, the input location 512 where it allows a user 102 to manually enter information such as country, state, city, village into the database record.

After the location has been entered, the next step is to input the payment information into the database record. This is done by the input payment 514 step whereby the amount paid is added to the record. Next a user 102 selects the currency unit that was used to purchase the transaction subject 204. The system may automatically suggest a currency based on the location selected, but a user can override this suggestion even if provided by the system. Next, the user 102 will input the size and quantity 518 of the transaction subject 204. Continuing, the user 102 has the option to add additional information 520 on the transaction subject 204 to the record in the database 118. A personal story, experience, or other helpful hints are a type of information that could be entered under the add additional information 520 step.

The user 102 can then choose to submit review data 522 in the next step of the process. If the user 102 desires to include review data 220, then the user 102 proceeds to add review information 524 step and adds review data 220 with respect to the transaction subject 204 purchased, the vendor 218 from whom the transaction subject was purchased and the overall experience from the user 102. Once the additional review information has been entered or if the user 102 chose not to submit review data 220, the final step before being added to the database 118 is the review and submit transaction subject 526 step. At the review and submit transaction subject 526 step, the user 102 can review all their inputs for the transaction subject 204 before submitting them to the database 118.

FIG. 6 illustrates the request transaction subject 600 process. Once a user 102 decides to request a transaction subject 204 the process initially asks the user 102 whether they want to use current location 602. If the answer is yes, then the process proceeds to browse by category for transaction subject 606 step or if the user 102, decides not to use their current location as if they were in a hotel planning a trip out into the local area which may be the case, the user 102 would proceed to the select location 604 step and choose the location they desire. After this step is completed, the user 102 proceeds to the browse by category for transaction subject 606 step as identified earlier.

This step allows a user 102 to browse by a category 216 instead of a specific transaction subject 204. For example, a person traveling may want to experience the fruit of the local area and this step allows the user 102 to select the category 216 and view what fruits have been purchased or are available in the local area. However, if the user 102 knows the specific transaction subject 204 they desire this step may be bypassed when continuing from the select location 604 or use current location 602 steps.

Next a specific transaction subject 204 is chosen or entered in the select transaction subject 608 step if available. However, if the user 102 selects a transaction subject 204 that is currently not in the database 118, they may follow an alternative path to determine the price by posting a picture and description 618 and requesting users 102 to provide a price on the posted transaction subject 620. Once a price is received with at least the minimum details required by the system, the alternative process skips the next step, selecting records and determining the expected price 610, and proceeds to select adjustment factors to apply 612 step. Continuing with original process, once the location has been determined and the transaction subject 204 has been selected this creates a query wherein the next step selects records and determines expected price 610 is executed.

The expected price may be based on sets of transaction subjects 204, where the one set is used for a generic expected price which may include all the appropriate subject transactions 204 and another set is used for a certified user's expected price which includes user's 102 inputs where the users 102 have obtained at least one of the certifications described above. The certified user's expected price will typically be a subset of the database. The expected price may be computed using several mathematical techniques such as averaging/mean, mode, weighted averaging, range averaging, standard deviation, and variance but is not limited to these specific techniques. For example, the weighted average may place lower weights on prices that are older and increasing the weights as they approach the current date. Additionally, range averaging may discard the highest and lowest prices or the oldest dates before computing the expected price. Prices outside a selected standard deviation or variance may be discarded before computing the expected price. These techniques may be selectable during the selecting records and determining the expected price 610 step. After this step has been completed, the system or user 102 may choose the appropriate adjustment factors 228 to apply in the select adjustment factors to apply 612 step. Next the process applies these adjustment factors in the apply adjustment factors to determine expected price 614 step to the selected records and determines the expected price based on a transaction subject 204 algorithm and the adjustment factors 228 selected. When the algorithm and adjustment factors 228 have been applied to the transaction subjects 204 requested, the system will display the expected price of the transaction subject 204 requested, other records matching the request, and the associated reviews.

Having thus described the invention, I claim:

1. A computer-implemented system for providing payment information for a transaction subject in a location, the system comprising:
a. a database having—
i. user profile data,
ii. transaction subject payment data including the transaction subject, price, currency, date, and location,
iii. at least one adjustment factor, and
iv. review data;
b. a user interface having—
i. at least one user inputting data relating to payment for at least one transaction subject in at least one location,
ii. at least one user requesting data relating to payment for at least one transaction subject in at least one location,
iii. selection of at least one adjustment factor,
iv. adjustment of an expected price based on at least one adjustment factor,
v. at least one user receiving data relating to the payment for at least one transaction subject in at least one location;
c. at least one user device in communication with the user interface;
d. a transaction subject input engine interactively facilitating each user input of data related to payment for a transaction subject and generating a database record related to the transaction subject;
e. a transaction subject output engine having—
i. a query generator interactively facilitating each user request and generating a query most closely related to the transaction subject and location in view of each applicable adjustment factor, and
ii. a response generator receiving the query and applying adjustment factors to relevant transaction subject payment data to generate a response including expected price information for the transaction subject in the location,
whereby the price for a particular transaction subject at a specific location is determined based on user-provided data as a function of a user request and application of applicable adjustment factors.

2. The system of claim 1, where the transaction subject database is preloaded with a set of expected prices for at least one transaction subject in at least one location.

3. The system of claim 1, where the transaction subject database records include categories of transaction subjects.

4. The system of claim 3, where the price of a category of transaction subjects are determined by selecting a specific set of transaction subjects common to the areas to be compared.

5. The system of claim 1, where users earn levels of certification based on factors including reliability of their reviews, number of reviews, location of reviews, detail provided for transaction subjects, and prior indicia of reliability.

6. The system of claim 1, where administrator approval is required for at least one selected from users, comments, transaction subject data flagged according to specified criteria.

7. The system of claim 1, wherein some portion of transaction subject payment data is entered by a user scanning a transaction subject code.

8. The system of claim 1, wherein a user maybe shown an expected price selected from a calculation based on: average (mean), mode, weighted average, range average, standard deviation, and a variance.

9. The system of claim 1, wherein a certified user's expected price selected from a group based on certification levels: trusted user, world traveler, collector, and local.

10. The system of claim 9, wherein a user maybe further shown a certified user's expected price selected from a calculation based on: average (mean), mode, weighted average, range average, standard deviation, and a variance.

11. The system of claim 1, wherein the adjustment factor selection includes processing the user data based on at least one predetermined parameter of the database.

12. The system of claim 1, wherein the output engine further suggests at least one location near the user's location where a desired transaction subject may be available.

13. The system of claim 12, where the user's location is provided by an automated positioning capability of the user device.

14. The system of claim 13, where the automated positioning capability is selected from the following: multilateration, triangulation, global positioning system, WIFI, and a hybrid of at least two of the other types of capabilities.

15. The system of claim 1, where the expected price of the transaction subject is displayed in a local currency based on the user's location.

16. The system of claim 1, where at least one adjustment factor is selected from a group including: location, season, currency exchange rate, authenticity, inflation rate, transaction subject availability, size, recency, distance, market variables, political boundaries, user credibility, level of negotiation, and statistical analysis.

17. The system of claim 1, the transaction subject payment data including rating information regarding the transaction, the rating information selected from: vendor rating, transaction subject rating, authenticity, and level of negotiation.

18. The system of claim 1, where the Internet protocol address of a user device is captured when a user inputs a transaction subject record and translated to a physical location.

19. The system of claim 18, where an administrator may block at least one Internet protocol address.

20. The system of claim 1, the query generator interpreting a request in view of at least one predetermined setting including at least one of the following: transaction subject category, proximity of vendor, review of vendor, review of transaction subject, and price.

21. The system of claim 20, wherein the response includes at least information about at least one vendor expected to offer at least one transaction subject under payment terms consistent with the predetermined settings.

22. The system of claim 20, wherein a cart contains more than one transaction subject selected by the user from at least one query and placed into the cart and aggregates the total of the expected prices for transaction subjects in the cart.

23. The system of claim 22, wherein the cart allows a user to remove transaction subjects.

24. The system of claim 22, where at least one checkout action is selected from a group including: saved searches, suggested vendors, and total expected price for transaction subjects in the cart.

25. The system of claim 24, wherein the vendor is selected based on factors including: total expected price, number of transaction subjects available, and a combination thereof.

26. The system of claim 1, where the user device is selected from a group consisting of a laptop, mobile device, tablet and desktop.

27. A computer-implemented method for providing payment information for a transaction subject in a location, the method comprising:
a. receiving payment information data from at least one user for at least one transaction subject in at least one location;
b. creating a record in a database for each user entry of payment information;
c. collecting adjustment factor data relevant to calculation of expected price information for at least one transaction subject in at least one location;
d. creating at least one record in the database for adjustment factor data;
e. creating at least one record in the database for review data;
f. receiving an interactive request from at least one user for payment information for at least one transaction subject in at least one location based on user selected criteria;
g. creating a query response for at least one user request for payment information for at least one transaction subject in at least one location based on user-selected criteria;
h. selecting at least one record related to payment information for a transaction subject in a location based on the user request;
i. calculating expected price information for the transaction subject in the location based on data from selected transaction subject payment records;
j. applying at least one adjustment factor to the expected price information to generate an expected price information result; and
k. providing at least one expected price information result to a user derived from database information modified by at least one adjustment factor,
whereby a user can solicit expected price information for a transaction subject in a location based on data input by other users regarding payments for similar transaction subjects in similar locations and other applicable adjustment factors.

28. The method of claim 27, where a transaction subject database is preloaded with at least one expected price for at least one transaction subject in at least one location.

29. The method of claim 27, where users earn levels of certification based on reliability of their reviews, number of reviews, and location of reviews.

30. The method of claim 27, where administrator approval is required for at least one selected from users, comments, transaction subject records, or other database information that are flagged according to certain criteria.

31. The method of claim 27, wherein at least one element of transaction subject payment information data is entered by scanning a transaction subject code.

32. The method of claim 27, wherein transaction subject payment information data includes at least one of the following: transaction subject, price paid, location, date and time of purchase, and quality of transaction subject.

33. The method of claim 32, where a user's location is provided by an automated positioning capability of the user device.

34. The method of claim 33, where the automated positioning capability is selected from the following: multilateration, triangulation, global positioning system, WIFI, and a hybrid of at least two of the foregoing.

35. The method of claim 27, wherein a user maybe shown an expected price selected from a calculation based on: average (mean), mode, weighted average, range average, standard deviation, and a variance.

36. The method of claim 27, wherein a certified user's expected price selected from a group based on certification levels: trusted user, world traveler, collector, and local.

37. The method of claim 36, wherein a user maybe further shown a certified user's expected price selected from a calculation based on: average (mean), mode, weighted average, range average, standard deviation, and a variance.

38. The method of claim 27, where the expected price of the transaction subject is displayed in a local currency based on the user's location.

39. The method of claim 27, the transaction subject payment information data input engine further receiving ratings information regarding at least components of the transaction selected from: vendor rating, transaction subject rating, and level of negotiation.

40. The method of claim 27, where the Internet protocol address of a user device is captured when a user inputs a transaction subject data and translated to a physical location for comparison to the location reported by the user.

41. The method of claim 27, where the administrator may block at least one specific Internet protocol address.

42. The method of claim 27, where the transaction subject database records include categories.

43. The method of claim 42, where the price of a category of transaction subjects are determined by selecting specific sets of transaction subjects common to the areas to be compared.

44. The method of claim 27, wherein at least one adjustment factor can be updated.

45. The method of claim 39, wherein the review data includes at least one of the following: review category, transaction subject review, vendor review and helpful votes.

46. The method of claim 27, wherein a request in view of predetermined settings includes at least one of the following: transaction subject category, proximity of vendor, review of vendor, review of transaction subject, and price.

47. The method of claim 27, wherein the response includes processing the user data based on predetermined parameters of the database.

48. The method of claim 27, wherein the response includes at least information about at least one vendor believed to be offering the transaction subject under payment terms consistent with the predetermined settings.

49. The method of claim 27, wherein the response further suggests at least one location near the user's location where the transaction subject is expected be available.

50. The method of claim 27, wherein payment information data includes at least one of the following: transaction subject, location, vendor, and pricing.

51. The method of claim 27, where at least one adjustment factor is applied to the calculated payment data, the adjustment factor selected from a group including: location, season, currency exchange rate, authenticity, inflation rate, transaction subject availability, size, recency, distance, market variables, political boundaries, user credibility, level of negotiation, and statistical analysis.

52. The method of claim 27, wherein at least one adjustment factor is applied to a category of transaction subjects for comparison.

53. The method of claim 27, wherein user requesting price data can communicate with a user that submitted the price data.
